(19) United States
(12) Patent Application Publication
(10) Pub. No.: US 2002/0130903 A1
(43) Pub. Date: Sep. 19, 2002

(54) System, method and article of manufacture for a graphical sender interface for use in an integrated scheduling and document management framework

(75) Inventor: Dann E. Kroeger, Palmetto, FL (US)

Correspondence Address: Hovey, Williams, Timmons & Collins, 2405 Grand Blvd., Suite 400, Kansas City, MO, 64108, US

(73) Assignee: ATUB, Inc.

(21) Appl. No.: 09/746,206

(22) Filed: Dec. 23, 2000

(51) Int. Cl. G06F 3/00; G06F 13/00

(52) U.S. Cl. 345/752; 345/780

(57) ABSTRACT

A system, method and computer program product are provided for affording a graphical user interface for task management. Such interface displays a plurality of fields including a recipient field, a message field, and a response date field. In use, a sender is allowed to enter a recipient of an electronic mail message utilizing the recipient field. Further, the sender is permitted to enter text to accompany the electronic mail message utilizing the message field. Still yet, the sender is allowed to specify a response date using the response date field.

### FIELD OF THE INVENTION

The present invention relates to management systems, and more particularly to a scheduling and document management framework.

### BACKGROUND OF THE INVENTION

Construction is a very large, and fast growing market. Total construction has grown from 555 billion dollars in 1995 to over 784 billion dollars in 1999. The 784 billion dollars includes 552 billion dollars in private construction and 172 billion dollars in public construction. The private construction includes 348 billion dollars in residential dollars with 204 billion dollars in non-residential, office, hotels, motels, commercial, religious, educational, hospital, institutional, telecommunications, railroads, electric light & power, gas and petroleum pipelines. The 172 billion dollars in public construction includes 78 billion dollars in buildings with the remained composed of highways, streets, military facilities, sewer systems, and water supply facilities.

With the importance of the construction thus being quite evidenced, it is obvious that management of the construction process is key to handling such growth in an effective manner. Two major aspects associated with handling the construction process include scheduling and document management.

Scheduling

In the past, it has been common in development projects to make-up a list of development tasks to be performed for the entire development project and to determine the number of days and the order in which each development project has to be completed. These construction tasks, including overall areas of land design plans, permits, financing, etc., can be performed by a development company's or contractor's own crew or, alternatively, by sub-contractors which have subcontracted for a specific task, such as required in forming a slab edge or the rough plumbing, or rough electrical, obtaining inspector's approvals which tasks would be performed prior to pouring a building slab. The ordering of the trusses might be done at an early stage of the construction job with the delivery of the trusses and lumber package scheduled for a day and time to start the framing of a building.

Prior charts have been made which used various types of bar charts and bars which might indicate the number of days to perform each task. The bars on the charts sometimes overlap and give an indication of the total number of days required for the development project. These charts have had limitations in that a new chart is required every time there are delays in anyone of the selected tasks to be performed as a result of weather or having the subcontractors available at the proper time for the contract. In addition, the number of days in such charts does not take notice that some days, such as Sundays and holidays are not working days.

Prior art charting apparatus and methods can be seen in the prior art U.S. Pat. No. 4,483,680, to Daly, for a genealogical information recording and arrangement method and apparatus for recording and displaying genealogical and pedigree information on humans or animals. The data on individuals is recorded on a plurality of interconnectable discrete patterns imprinted on transparent self-adhesive material. The Deighton patent, U.S. Pat. No. 5,447,336, is a road pavement management instrument which includes a set of forms for management of road conditions which consist of a road inventory form and a construction form including locations, features, and pavement conditions. In the Coleman patent, U.S. Pat. No. 5,431,450, a medication board is provided which has a board listing of medications, dosages and times medications are to be taken and allows the board to be marked with a marker. The Gannon et al. patent, U.S. Pat. No. 5,011,911, is a view-through information converter for use with preprinted information listings, such as a television programming guide listings chart, and has a transparent plastic sheet superimposed onto the listings chart such that all listings presented on the television listing chart are viewable through the plastic sheet and converts television station numbers and call letters on the listing chart into numbers which are directly usable by the reader to identify television tuner locations.

The Hodge et al. patent, U.S. Pat. No. 4,559,705, is an indexing overlay for video display device and can be overlaid on a computer CRT or plasma digital displayer screen and is made of a high-static vinyl or acetate having columns and rows of discrete displayable positions. In the Bickley patent, U.S. Pat. No. 1,350,955, a production and material control system uses a chart in connection with a system for the control of production and materials in a factory in connection with a system with a control of production and materials in a factory and has a chart line designated for materials received and a second line designated for materials removed and a third line designated for orders received with indications of the length of progress for each designated operation.

Document Management

It is common in the building construction industry that architects or other design personnel draw up construction blueprints or plans either by hand or on a computer aided design (CAD) system. Such blueprints or working drawings include a general or primary plan drawing with supporting pages of detailed, secondary drawings supplementing and referencing the primary building drawing, i.e., floor plans, sectional views, etc., along with supporting textual specifications. The detailed drawings provide more specific information for various portions or areas of the primary plan drawing. In most areas, for bidding purposes, a single company distributes rolls of microfiche of the blueprint drawings or building plans in their entirety to interested contractors and subcontractors. Selected ones of the drawings on the microfiche are then viewed to provide information to estimate construction costs and prepare bid proposals on the work to be done. Though a contractor may be interested in only one particular portion of the building, that contractor must search through all of the plans in order locate the drawings of interest. Obviously, this type of system is inefficient and time consuming for each bidder.

It has been known in the art to input information into a computer for cost estimating analysis and reporting. Common computer systems may provide costs of material and provide reports thereof based on construction information specifically put into the computer. An example of such capability is illustrated in U.S. Pat. No. 5,189,606.

The U.S. Pat. No. 4,885,694 shows an automated building control design system. The system is computer based for substantially automating the designs of a building control system, such as pneumatic, electronic, environmental, energy management, automation, fire and security, and combinations thereof.

The U.S. Pat. No. 4,964,060 shows a building plan checking system which reviews building plans in view of required standards, such as zoning codes and regulations.

The U.S. Pat. No. 5,091,869 shows a building floor plan creating system which converts measurement data into a floor plan view.

The U.S. Pat. No. 5,111,392 shows a system for creating furniture layouts which utilizes standard furniture pieces. The finish, color and fabric can be separately determined for the furniture layout and pieces. Cost and bill of materials can be automatically produced based on the designed layout.

The U.S. Pat. No. 5,189,606 shows an integrated system for construction cost estimating, analysis and reporting of military projects based upon input parameters indicative of the type, size and location of the facility.

The U.S. Pat. No. 5,249,120 shows an automated manufacturing cost estimating system based upon the initial material and the operations to be performed.

The U.S. Pat. No. 5,255,207 shows a method for designing and detailing cabinets which allow a user to design cabinet structure by standard cabinet designs and to modify or override standard designs as desired. The program also allows the cost of the materials of the cabinets to be produced based on the design.

The U.S. Pat. No. 5,299,307 shows a method of drawing images by manipulating objects as to their size, dimension, location and positioning on the computer display.

The U.S. Pat. No. 5,319,541 shows a computer for aiding in the selection of roofing systems and generating the specifications therefor. The roofing system is selected from various design data entered by the user and the specifications are generated by applying the user entered design data to modify standard specifications.

The U.S. Pat. No. 5,526,520 shows a method for organizing and relating several documents, including graphic documents, by storing the documents in a plurality of files and identifying specific ones of the files with a particular project. The documents can be a primary document, such as a general view blueprint, and secondary documents, such as detailed drawings, textual and function files. The files are linked to one another by placing hotspots on the primary document to automatically call up the corresponding secondary document. Until now, there has been no effective integration of scheduling and document management in the context of construction.

### DISCLOSURE OF THE INVENTION

A system, method and computer program product are provided for affording a graphical user interface for task management. Such interface displays a plurality of fields including a recipient field, a message field, and a response date field. In use, a sender is allowed to enter a recipient of an electronic mail message utilizing the recipient field. Further, the sender is permitted to enter text to accompany the electronic mail message utilizing the message field. Still yet, the sender is allowed to specify a response date using the response date field.

In one embodiment of the present invention, electronic mail alerts may be sent automatically based on the response date. Further, such electronic mail alerts may be sent to the recipient, or even the sender.

In another embodiment of the present invention, at least two message fields may be displayed including a request message field and a response message field. Further, a project field may be displayed for allowing the sender to enter project information, and a subject field may be displayed for allowing the sender to enter subject information.

### BRIEF DESCRIPTION OF THE DRAWINGS

FIG. 1 illustrates a method for scheduling and document management integration, in accordance with one embodiment of the present invention;

FIG. 1A illustrates an exemplary environment in which the present invention may be implemented;

FIG. 2 shows a representative hardware environment associated with the computer systems of FIG. 1A;

FIG. 3 illustrates a method for providing a project task manager, in accordance with one embodiment of the present invention;

FIG. 4 illustrates a method for managing documents, in accordance with one embodiment of the present invention;

FIG. 5 illustrates a plurality of templates that may be used to initiate projects in the context of the document manager;

FIG. 6 illustrates a method for affording a communication manager, in accordance with one embodiment of the present invention;

FIGS. 7 and 8 illustrate graphical user interface that may be used in association with the communication manager of the present invention;

FIG. 9 illustrates a method for affording a bid manager, in accordance with one embodiment of the present invention;

FIG. 10 illustrates a method for affording a pro-active manager, in accordance with one embodiment of the present invention;

FIG. 11 illustrates a method for affording a contact manager, in accordance with one embodiment of the present invention;

FIG. 12 illustrates a method for alerting a manager of an outstanding task; and

FIG. 13 illustrates a method for managing a construction process.

### DESCRIPTION OF THE PREFERRED EMBODIMENTS

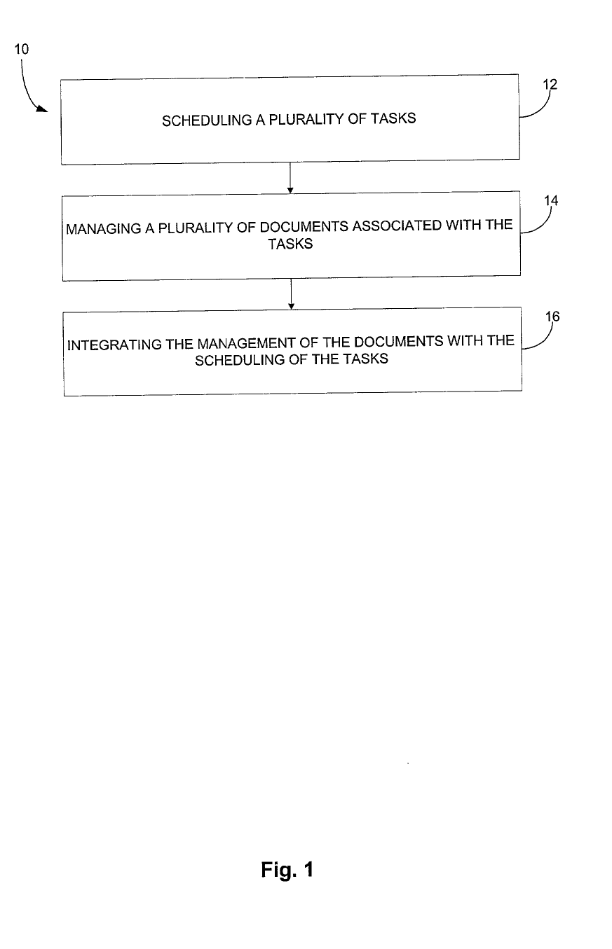

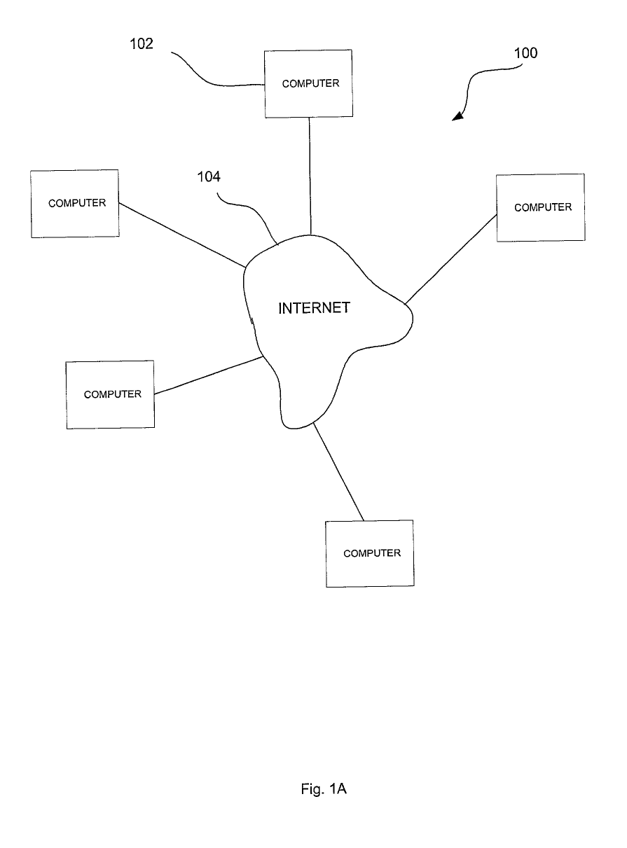

FIG. 1 illustrates a method 10 for scheduling and document management integration. During operation 12, a plurality of tasks are scheduled. Further, a plurality of documents associated with the tasks are managed. See operation 14. In operation 16, the management of the documents is integrated with the scheduling of the tasks. In one embodiment, such scheduling and document management integration may be applied in the context of the construction industry. It should be noted, however, that the various principles of the present invention may be carried out in any desired manner, and in any desired environment. Additional information regarding such integration will be set forth herein after a detail description of possible architectures is set forth.

FIG. 1A illustrates an exemplary environment 100 in which the present invention may be implemented. As shown, a plurality of computers 102 are interconnected via a network 104. In one embodiment, such network includes the Internet. It should be noted, however, that any type of network may be employed, i.e. local area network (LAN), wide area network (WAN), etc.

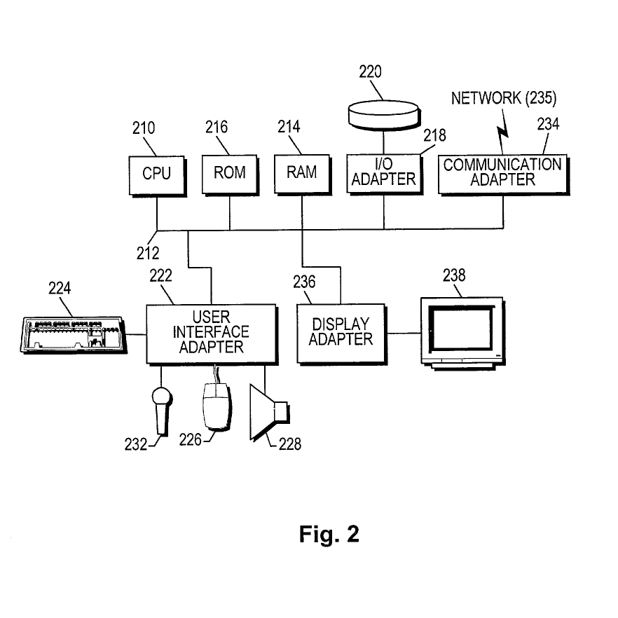

FIG. 2 shows a representative hardware environment associated with the computer systems 102 of FIG. 1A. Such figure illustrates a typical hardware configuration of a workstation in accordance with a preferred embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network (e.g., a data processing network) and a display adapter 236 for connecting the bus 212 to a display device 238. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code.

Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small-scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Bemers-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

Preferred Embodiments

The present invention may provide services as an application service provider (ASP) with a customer hosting option. All information may be stored centrally on a company server or on a customer's server. The present invention may also use SQL as the server data manager. This database may provide real time access to all pertinent project information and may use “active agents” to monitor critical elements of all projects to notify the proper persons by email, voicemail, handheld or auto-fax when tasks fall behind.

One goal of the present invention is to provide a pro-active web system that alerts project managers, and others who need to know, ahead of time so they can take action and bring projects in under budget. The present invention is further capable of utilizing the web as a pro-active integrated project management hub.

The present invention is designed to easily adapt to any industry requiring pro-active project management. These industries include, but are not limited to, the A/E/C (Architects, Engineers & Contractors), Computer Software Development markets, etc. In the A/E/C environment, the present invention may provide easy access to information across an entire market including owner/developers, brokers, architects, engineers, contractors, sub-contractors and project managers. The present invention may cover the entire project management cycle including project planning, budgeting/financing, land acquisition, site engineering, zoning, building design, permitting, construction and project close-out.

Overall, the present invention integrates scheduling and document management into a single pro-active task oriented project management system. The present invention is pro-active, alerting system users of important tasks not receiving required attention. Since scheduling and document management are integrated, the system can alert users of pending needs before they become critical. In the A/E/C market, for example, if a “request for information (RFI)” is outstanding on a task that will soon become a “critical path” item, the system may send e-mails, voicemail, hand-held device (HHD) mail, or faxes to appropriate personnel. The present invention may also fully integrate project estimates with execution. At all times the system may provide real time updates to original estimates identifying most likely outcomes.

The design focus of the present invention is to combine project management and scheduling into an integrated task driven system with responsibilities clearly assigned. This functionality is accomplished through the seamless integration of the following interrelated modules:

Project Task Manager

Document Manager

Bid Manager

Communications Manager

Pro-Active Manager

Resource & Contact Manager

Reports Manager

These modules may interface with a Timberline Accounting Management System. Additional information regarding the various modules will now be set forth in greater detail.

Project Task Manager (PTM)

All elements of a project from inception through completion may be treated as tasks. Each task has associated information about administration, schedules, budgets and related documents. Table 1 illustrates exemplary administration, schedule, and budget information associated with each task. It should be noted that bracketed information indicates how the information is captured, i.e. PM Project Manager or General Contractor.

TABLE 1

Administration Information includes:
Task description [PM - Text]
Viewing Level [PM - Drop Down]
CSI code (if applies) [PM - Drop Down]
Person(s) responsible for the task completion [PM - Drop
Down]
Person assigning the task [PM - Drop Down]
Person(s) to be notified when the task has activity [PM
- Drop Down]
Schedule information includes:
Predecessor task(s) [PM - Drop Down]
Start Date Constraint [PM - Calendar]
End Date Constraint [PM - Calendar]
Original Duration [PM - Drop Down]
Original Start Date [System]
Original End Date [System]
Total Float [System]
Free Float [System]
Current/Actual Duration [Supervisor reports]
Current/Actual Start Date [Supervisor reports]
Current/Actual % Complete [Supervisor reports]
Current/Actual Remaining Duration [System]
Budget information includes:
Material Quantity [PM - Numeric]
Material Units [PM - Drop Down]
Material Cost/Unit [PM - Numeric]
Material Base Cost [System]
Material Tax [PM - Numeric]
Material Freight [PM - Numeric]
Material Total [System]
Labor Crew size [PM - Numeric]
Labor Work Rate [PM - Numeric]
Labor Man Hours [PM - Numeric]
Labor Cost/Man Hour [System]
Labor Base Cost [System]
Labor Overhead [PM - Numeric/Drop Down]
Labor Total [System]
Subcontract Bid Estimate [PM - Numeric]
Subcontract Winning Bidder [PM - Drop Down]
Subcontract Contracted Cost [System]
Total Contract [System]
Contract Change Orders [System]
Total Contract and Change Orders [System]
Dollars Paid Out [System]
Summing Levels for Material, Labor, Subcontract,
Contract Change Orders & Dollars Paid Out [PM - Drop
Down]

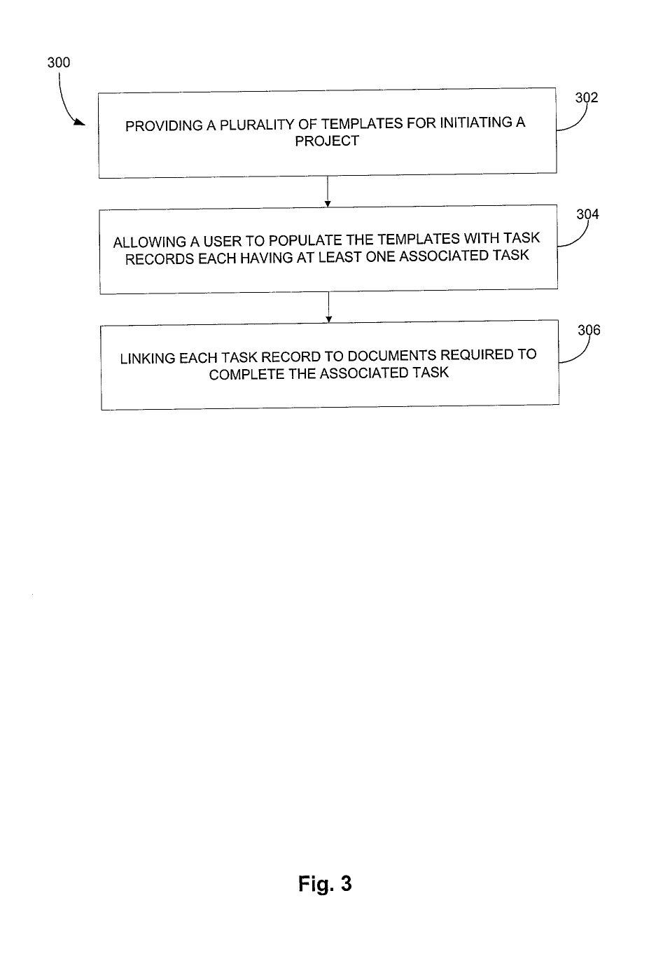

FIG. 3 illustrates a method 300 for providing a project task manager function. Initially, in operation 302, a plurality of templates are provided for initiating a project. In one embodiment, the templates may each indicate which tasks are necessary to complete the associated project. Table 1A illustrates a plurality of exemplary templates that may be utilized in the construction environment. Such templates are for illustrative purposes, and should not be construed as limiting in any manner.

TABLE 1A

Project Preliminaries
Assemble Project Team
Prepare Short List of Contractors
RFP Process
Interview & Evaluate Design/Build Teams
Select/Contract Design/Build Team
Finance
Preliminary Review of Project Economics and
Feasibility
Secure Equity Financing
Secure Debt Financing
Negotiate Loan Documents
Site Acquisition
Determine Site Requirements
Select Broker
Identify Eligible Sites
Evaluate Preferred Sites
Select & Contract Site/Earnest Money
Contract is Executed
Site Due Diligence
Site Inspection & Planning
Governmental Approvals - Final Plat &
Development Plan
Site Plan Approval
Board Review & Approval
Close on Land
Building Design
Conceptual Design
Preliminary Design Package
Schematic Design Package
Design Development Package
Project Feasibility Analysis
Construction Documents & Permitting
Plan Review & Modifications
Permitting - Submit, Review & Approval
Competitive Bid Process
GMP for Construction
Grading & Foundation Permit
Permit
CONSTRUCTION
General Conditions
Sitework
Mass Excavation
Dewatering
Site Utilities
Curb and Gutter
Sidewalks
Asphalt
Fine Grade
Landscaping & Irrigation
Building Construction
Concrete Foundation
Under Slab Rough In
Mechanical Underslab
Electrical Underslab
Plumbing Underslab
Concrete Floor Slab
Rebar
Masonry
Stone
Structural Steel
Material
Installation
Rough Carpentry/Glu Lams
Roof Framing
Millwork
Built Up Roof
Metal Roof/Sheet Metal
Exterior Finishes
Aluminum Frames
Glass and Glazing
Doors and Frames
Studs/Drywall
Accoustical Ceiling
Carpet & VCT
Tile
Paint and Wailcovering
Exterior Signage
Furniture and Fixtures
Plumbing Rough-in
Plumbing Finish
Mechanical Rough In
Mechanical Finish
Electrical Rough In
Electrical Finish
Punch List
ATUBWeb FF&E
Data/Telephone Rough-in
Furniture
Data/Telephone Finish
Personnel Moves
Final Occupancy

Optionally, a secure login may be required for editing the templates. Further, a log may be created for tracking the manner in which users have edited the templates.

Further, in operation 304, a user is allowed to populate the template with task records each having at least one associated task. As an option, each task record may indicate each previous task carried out prior to the associated task, and each subsequent task to be carried out after the associated task. Moreover, each task record may indicate a cost of the associated task with respect to other tasks. For that matter, the task record may include any information relating to the associated task.

Each task record is linked to documents required to complete the associated task. Note operation 306. In a web-based implementation, such link may include a hyperlink using hypertext mark-up language (HTML).

The project task manager thus provides templates to initiate projects. Note Table 1A. The task records may include drop down lists which may be user-defined and lists of current data in other files (such as contact names). Further, the date fields may use calendars. Table 2 illustrates information (in addition to the information of Table 1) that may be included in the task records, and a data structure thereof.

TABLE 2
Data File Structures

Company File:
Name
Division
Homepage
Category/Type (Pop list - Multiples)
Notes
Contact File:
Name
Company
Title
Home address (3 lines + city/state/zip/country)
Work address (3 lines + city/state/zip/country) (carries
over from prior on same company with over-ride)
Work phone - extension
Home phone
Cell phone
Fax
Email
Email cell
Group (Pop list - Multiples)
Site evaluations & assessments flag
(Read/Write/Submit/Retrieve)
Drawings flag
Specifications flag
Addenda flag
Purchase Orders flag
Contracts flag
Inspections flag
Tests flag
Material Inventory flag
Requests for Information flag
Change Proposal Requests flag
Change Proposal Quotations flag
Contract Change Orders flag
Submittals flag
Notes
Project File:
Project Name
Project Number (20 characters alpha-numeric)
Description
Type of Building (pop list)
Type of Construction (pop list)
Size
Overall Project Cost
Locations (3 lines address, city, state, zip, country)
(state & country are pops)
Region (Pop list - multiples)
Owner (from contact list - multiples)
Developer (from contact list - multiples)
Tennant (from contact list - multiples)
Architect (from contact list - multiples)
Engineering (from contact list - multiples)
General Contractor (from contact list - multiples)
Superintendent (from contact list - multiples)
Contracts (links to multiples that reside in the
document manager)
Start Date
Expected Finish Date
General Notes
RFI File Tracking:
“From” Email Address (Originators)
“To” Contacts (multiples). Should work similar to
outlook permitting more than one contact list and
grouping within lists.
“CC” Contacts (multiples)
“BCC” Contacts (multiples)
RFI Number. System generated (RFI + date + 01, etc) and
used to “match” up responses. One RFI may require
responses from more than one person.
Single Subject (memo field)
Question Box (memo field)
Related Document Names (multiples with path to central
server - selected through typical file tree dialogue
box)
Related Tasks (multiples). User selects from pop up
list of tasks & levels.
Response Box (memo field)
Needed By (date field using pop-up calendar). System
warns when tasks and system configuration grace dates
conflict.
RFI Completed? Yes or no choice entered by originator
of RFI.
Email Reminder Days. Will use system configuration
default that can be over-ridden. System automatically
re-sends email daily after so many days if RFI completed
remains “no”.
Date & time original RFI sent.
Change Proposal Request File Tracking:
“From” Email Address (Originators)
“To” Contacts (multiples). Should work similar to
outlook permitting more than one contact list and
grouping within lists.
“CC” Contacts (multiples)
“BCC” Contacts (multiples)
CPR Number. System generated (CPR + date + 01, etc) and
used to “match” up responses.
Single Subject (memo field)
Change Proposal Request (memo field)
Related Document Names (multiples with path to central
server - selected through typical file tree dialogue
box)
Related Tasks (multiples). User selects from pop up
list of tasks & levels.
Response Box (memo field)
Needed By (date field using pop-up calendar). System
warns when tasks and system config grace dates conflict.
CPR Completed? Yes or no choice entered by originator
of RFI.
Email Reminder Days. Will use system config default
that can be over-ridden. System automatically re-sends
email daily after so many days if CPR completed remains
“no”
Date & time original CPR sent.
Change Proposal Quotations File Tracking:
“From” Email Address (Originators)
“To” Contacts (multiples). Should work similar to
outlook permitting more than one contact list and
grouping within lists.
“CC” Contacts (multiples)
“BCC” Contacts (multiples)
CPQ Number. System generated (CPQ + date + 01, etc) and
used to “match” up responses.
Single Subject (memo field)
Change Proposal Request (memo field)
Related Document Names (multiples with path to central
server - selected through typical file tree dialogue
box)
Related Tasks (multiples). User selects from pop up
list of tasks & levels.
Response Box (memo field)
Needed By (date field using pop-up calendar). System
warns when tasks and system config grace dates conflict.
CPQ Completed? Yes or no choice entered by originator
of CPQ.
Email Reminder Days. Will use system config default
that can be over-ridden. System automatically re-sends
email daily after so many days if CPQ completed remains
“no”
Date & time original CPQ sent.
Contract Change Order File Tracking:
“From” Email Address (Originators)
“To” Contacts (multiples). Should work similar to
outlook permitting more than one contact list and
grouping within lists.
“CC” Contacts (multiples)
“BCC” Contacts (multiples)
CPQ Number. System generated (CC0 + date + 01, etc) and
used to “match” up responses.
Single Subject (memo field)
change Proposal Request (memo field)
Related Document Names (multiples with path to central
server - selected through typical file tree dialogue
box)
Related Tasks (multiples). User selects from pop up
list of tasks & levels.
Response Box (memo field)
Needed By (date field using pop-up calendar). System
warns when tasks and system config grace dates conflict.
CCO Completed? Yes or no choice entered by originator
of CCO.
Email Reminder Days. Will use system config default
that can be over-ridden. System automatically re-sends
email daily after so many days if CCO completed remains
“no”
Date & time original CCO sent.
Submittal File Tracking:
“From” Email Address (Originators)
“To” Contacts (multiples). Should work similar to
outlook permitting more than one contact list and
grouping within lists.
“CC” Contacts (multiples)
“BCC” Contacts (multiples)
Submittal File Number (system assigned. S + Date + 01,
etc)
Document Names (with paths to central server)
CSI Division (pop-ups).
Related Tasks (multiples). User selects from pop up
list of tasks & levels.
Product Description and Quantities.
Date physical product sent (pop calendar)
How physical product sent (pop list)
Product tracking number (usually issued by UPS, etc.)
Date physical product received
By whom (contact file pops)
Question Box. Used by QC/PM for clarification.
Submittal status (pops)
Needed By (date field using pop-up calendar). System
warns when tasks and system config grace dates conflict.
Submittal attachments (multiples) (like outlook but must
remained linked with this file?)
Submittal Completed? Yes or no choice entered by QC/PM.
Email Reminder Days. Will use system config default
that can be over-ridden. System automatically re-sends
email daily after so many days if Submittal Completed
remains “no”.
Date & time submittal sent.
Project Task Manager File:
Sequence number (internally generated - allows system to
determine how to sum various levels - needs to allow for
insertion of tasks after the project is initially set
up)
Description
Level (Phase, Division, Sub-division, detail, sub-
detail)
Original start date
Original duration
Original completion date
Current expected start date
Current expected duration
Current expected completion date
Remaining days
Percent complete
Actual start date
Actual completion date
Actual duration
Start date constraint
End date constraint
Total Float
Free Float
Predecessor activities (multiples)
Successor activities (multiples)
Person responsible for task
Other persons to inform task status (multiples or
grouped contacts)
Budget Only?
Budget Quantity
Budget Units
Budget Unit cost
Budget Work rate
Budget Work unit
Budget Duration
Crew
Bids (multiples - see Bid File)
Revised Cost
Payments due (multiples with dates & amounts?)
Assigned responsibility
Security levels (defines what type of person - based on
sign-on - does not read, reads, reads/writes)
Links to documents manager (multiples)
Location
Person creating task
Document Manager File:
Document sent to
Document sent on
Document due back date(s)
Document reference number
Document received from
Document received on
Document related to tasks (child file)
Bid File:
As indicated in the Bid Manager, the system needs to
“place together” all tasks into a Request for Bid.
There will be multiple Request for Bids on the same
project. The system then needs to retain all bid
responses from all companies. Companies may not respond
to all tasks on bids. And not all tasks on bid
responses may he accepted.
Further Items:
Site evaluations & assessments
Addenda
Purchase orders
Applications for payment
Manpower reports
Field work directives

With respect to the task records, the aforementioned links may allow access to all documents required to complete the task. Further, each task record may display all predecessor and successor tasks, and its budget relationship to other tasks (through summing levels), as mentioned earlier.

As set forth hereinabove, tasks may be edited/added at any time by authorized contacts. Further, the project task manager may provide an audit trail of all task changes made, when they were make, and by whom. The project task manager may also display bar graphs and calendars of schedule tasks & relationships over a scrolling time period. As such, the project task manager may display real time projections of budgets and actual costs.

Document Manager

The present invention maintains all documents in an organized fashion using a document manager for easily accessibility. The document manager may organize documents in a normal MICROSOFT EXPLORER folder/file “tree” format. Documents are added to the system by placing them in the appropriate folder. Documents may be viewed using the tree, performing a “find” function or linking from related tasks.

Table 3 illustrates various exemplary documents maintained by the document manager in the context of construction.

TABLE 3

Site evaluations & assessments
Drawings
Specifications
Addenda
Purchase Orders
Contracts
Inspections
Tests
Material Inventory

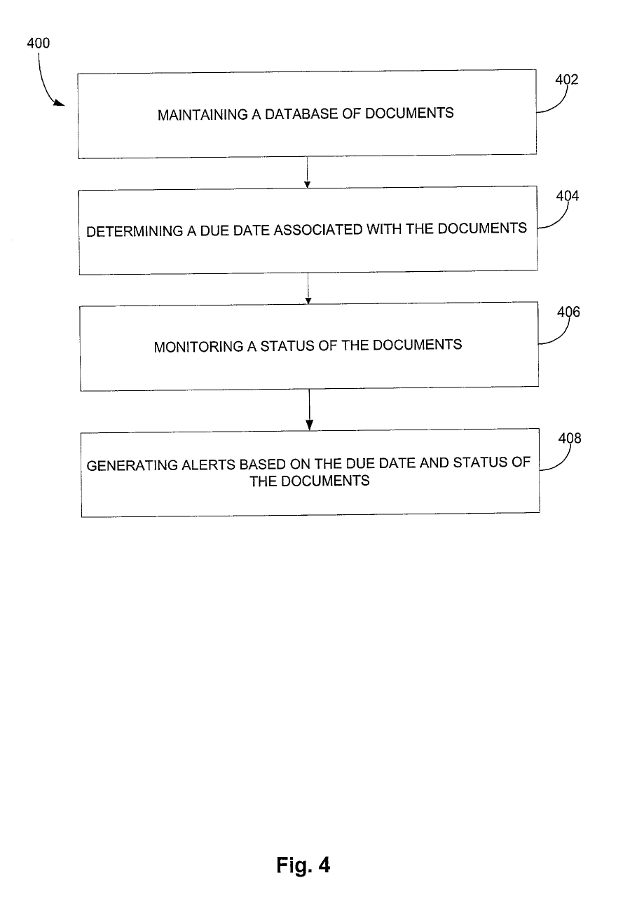

FIG. 4 illustrates a method 400 for managing documents. Initially, in operation 402, a database of documents is maintained. In one embodiment of the present invention, the documents may include site evaluations & assessments, drawings, specifications, addenda, purchase orders, contracts, inspections, tests, and/or material inventory. It should also be noted that the documents may have a plurality of different formats, and a universal browser may be used to view each of the documents.

Further, in operation 404, a due date associated with the documents is determined. A status of the documents is also monitored. Note operation 406. As an option, the status may indicate that the documents are submitted to the database. Further, the status may indicate that the documents are retrieved from the database.

Alerts are then generated in operation 408 based on the due date and status of the documents. Further, the alerts may include electronic message notifications. A destination of the electronic message notification may also be user-defined for each document. Moreover, the alerts may be generated upon completion of the documents being overdue. As an option, a log may be created indicating a person and a time associated with edits to the documents.

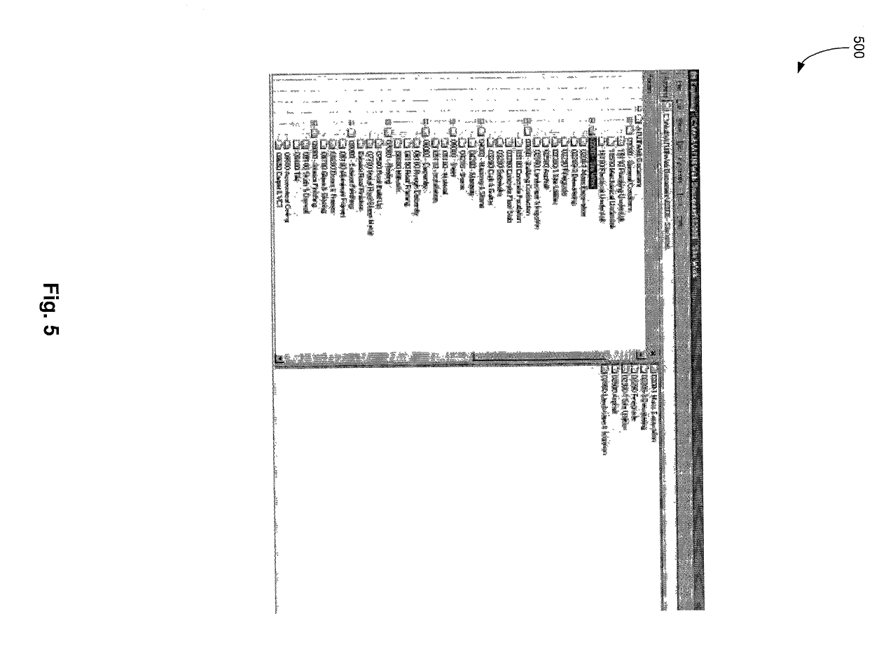

Similar to the project task manager, the document manager may also provide templates to initiate projects FIG. 5 illustrates a plurality of templates 500 that may be used to initiate projects in the context of the document manager.

The document manager may provide viewing of docs, xls, pdfs, xrefs, dwgs, & jpegs through a single browser viewer. Further, with system authorization, the document manager may permit any user to update all documents, but not necessarily xrefs & dwgs. The document manager may also record a time that any document is added or changed and by whom (for xrefs & dwgs, any time added, retrieved or resubmitted).

The document manager further tracks due dates for all documents, and provides easy access to downloadable drawings and specifications for use with Blue Print Shops, or any other print shop software.

The document manager may also include a user defined configuration file that identifies:

Who is notified when drawings & specifications are submitted (may be multiple people) & how (push email default)

Who is notified when drawings & specifications are retrieved & how

Who is notified when drawings & specifications submission is late & how

Who is notified when a drawings & specifications are retrieved and not re-submitted by due date and how

Communications Manager

The present invention further includes a communications manager capable of maintaining and tracking communication documents. The communications manager may interface with other proprietary systems (Email, Voicemail, HHD, and Faxes) for information exchange with architects, engineers and sub-contractors, or any other persons based on the environment in which the present invention is being used.

TABLE 4

Requests for Information
Change Proposal Requests
Change Proposal Quotations
Contract Change Orders
Submittals

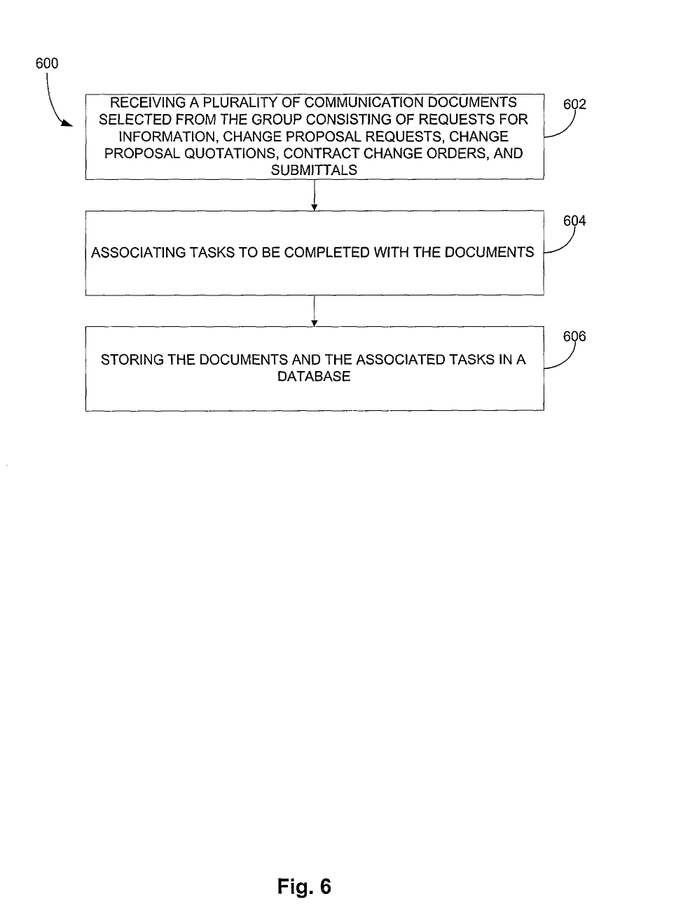

FIG. 6 illustrates a method 600 for affording a communication manager. Initially, in operation 602, a plurality of communication documents are provided. See Table 4. Optionally, a related file is capable of being associated with each document.

Next, in operation 604, tasks to be completed are associated with the documents. Such documents and the associated tasks are then stored in a database. See operation 606.

Further, a flag may be set upon the completion of the file. As an option, the file may be given a read-only status upon the flag being set. Further, a response date may be associated with each document. Moreover, an electronic mail notification may be automatically sent based on the response date.

Table 5 illustrates information that is maintained on communication documents.

TABLE 5

Document type (RFI, CPR, CPQ, CCO, Submittal)
Document reference number (Header + date + 01, etc)
Who sent the document
Who the document was sent to
Subject
When the document was sent
Related tasks
Related documents
All “text box - commentary” content
Response need by date (system may automatically generate
reminder e-mails based on system configuration files)
Document completed flag (may also be used to lock
documents)

The communications manager may provide for multiple requests for information (RFIs) to be referenced in change proposal requests (CPRs), multiple CPRs to be referenced in change proposal quotations (CPQs), and multiple CPQs to be referenced in contract change orders (CCOs).

The communications manager may further provide viewing of documents by type, reference number, due date, sender, and related tasks.

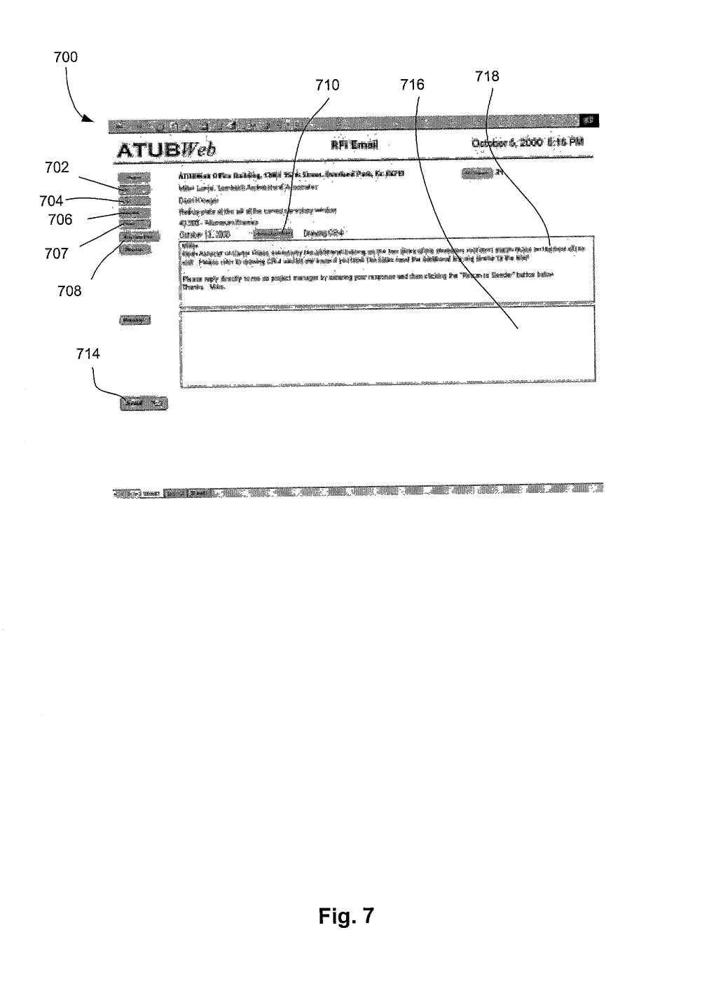

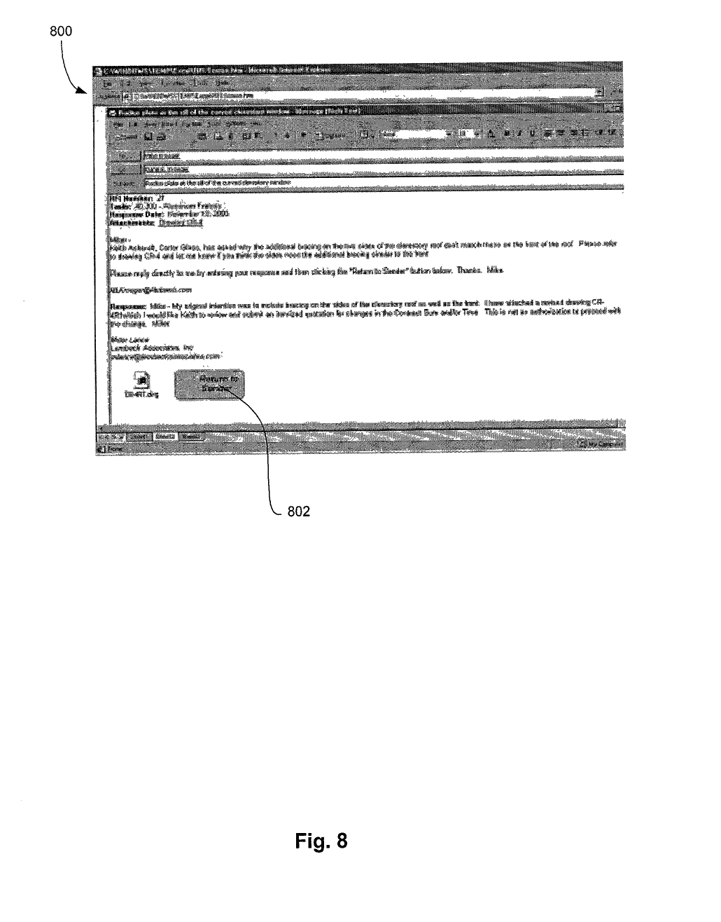

FIGS. 7 and 8 illustrate graphical user interfaces 700 and 800, respectively, that may be used in association with the communication manager of the present invention.

The present invention does not necessarily require sub-contractors or architects/engineers to have direct access to the central server. In fact, they can interact with the system through their own email, voicemail, HHD or fax systems. If sub-contractors or architects/engineers have web access to the central system, they may enter their information directly.

Following is a scenario that depicts a typical approach using e-mail. It should be noted that these types of activities can also be processed through voicemail, HHD and/or faxes. As mentioned hereinabove, various types of information are handled by the communication manager including, but not limited to a “request for information”, “change proposal requests”, “change proposal quotations”, “contract change orders” and “submittals.”

The “request for information” process begins by a sub-contractor or the like calling or e-mailing a general contractor/project manager (GC/PM) with a problem, or entering the information directly if they have access to a web server equipped with the capabilities of the present invention. The GC/PM uses the communication manager to create a new request for information (RFI) email. Note FIG. 7.

To construct the e-mail, a “To” icon 702 is used to select from a drop down menu with multi-selection similar to MICROSOFT OUTLOOK. Thereafter, a “CC” icon 704 is selected from a drop down menu with multi-selection also similar to MICROSOFT OUTLOOK. Fields adjacent to the icons 702 and 704 may also be filled manually. Subject information may be entered in a “Subject” field 706. Further, related tasks may be selected from a drop down/multi-selection task list using a task icon 707, as shown in FIG. 7. A “response needed by” date is subsequently selected from a calendar which may be displayed upon selection of a response needed icon 708. If such date is greater than any task deadline, the present embodiment may indicate an error condition.

A user may then attach links to any related documents from a drop down document tree using an attachment icon 710. Further, “Request” information may optionally be entered via a request icon. Thereafter, the user may click on a “Send” icon 714.

If the GC/PM is able to answer the sub-contractor's request, the GC/PM may enter the appropriate information in the response field 716 and click on a “Send” icon. Such response field 716 is separate from a text field 718 where message information may entered. Once sent, the system email/faxes the RFI information back to the subcontractor and “closes” the RFI.

Through internal checks, the communication manager may assigns a new RFI number to the message, time stamp the RFI, and record all information on a central server, generate links between the RFI to all tasks identified in the central database. The present embodiment may also forward an email/computer fax to all contacts. FIG. 8 illustrates how the e-mail may appear to the recipients.

A recipient may respond to the RFI by reading the question, linking to related documents if needed, and entering a response in the response field 716. The user may also issues a request for a “change proposal request”, if appropriate. When complete, the user may select the send button 802. Note FIG. 8. This button would not necessarily send the information as a normal e-mail, but rather connect with the communication manager and all pertinent information updated on the central server prior to being sent for synchronization purposes. Further, the communication manager may send confirmation e-mails to both the “from” and “to” recipients.

The “to” recipient (GM/PM) may review the RFI on-line (directly through the communication manager) and, if appropriate, close it and issue a “change proposal request” to the subcontractor(s).

Bid Manager

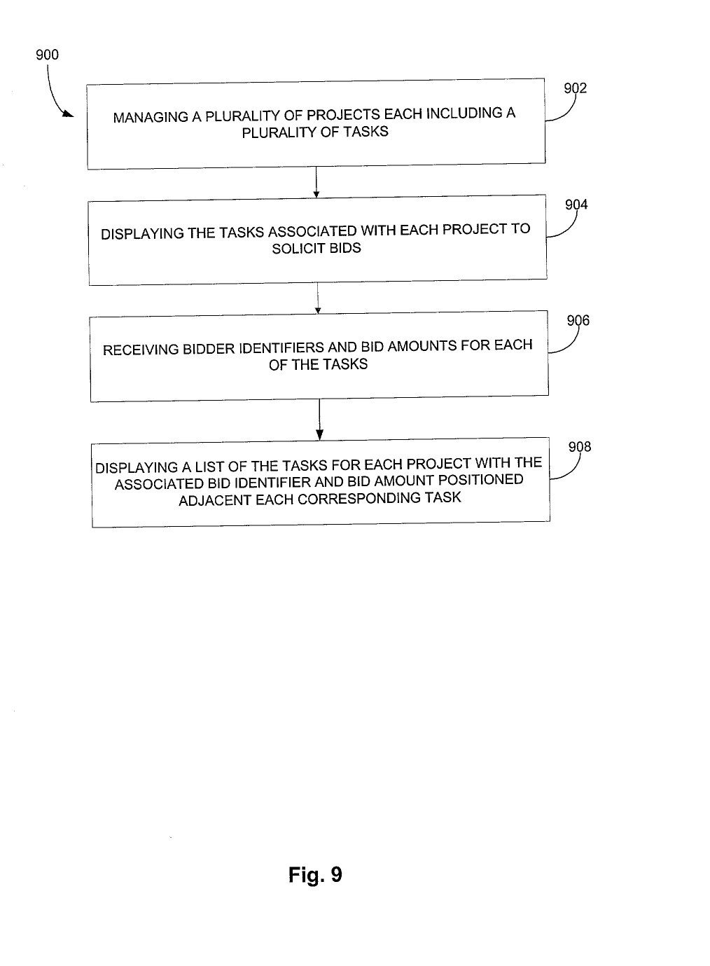

FIG. 9 illustrates a method 900 for affording a bid manager. First, in operation 902, a plurality of projects is managed, where each project includes a plurality of tasks. Further, in operation 904, the tasks associated with each project are displayed to bidders for soliciting bids. As such, in operation 906, bidder identifiers and bid amounts may be received for each of the tasks. A list of the tasks may be displayed for each project with the associated bidder identifier and bid amount positioned adjacent each corresponding task. Note operation 908. This facilitates management of the bids by a user.

To further facilitate management of the bids, a total bid amount may be calculated for each of the bidder identifiers. Further, the total bid amount may be calculated separately for each project.

As an option, the acceptance of the bid amounts may be permitted separately for each task on the list. Such acceptance may be transmitted to a bidder utilizing an electronic mail message based on the bidder identifier. Further, a link may be included in the electronic mail message for allowing the bidder to access a copy of the acceptance in a database utilizing a network. As an option, the network may be the Internet, and the link may be a hyperlink.

The bid manager thus maintains bids in real-time on the central server. The project manager identifies all tasks to be placed for bid in a “bid package” on the central server. Multiple bid packages may be created for each project. E-mails may be sent to contractors and subcontractors with a link to the appropriate bid package residing on the central server. For subcontractors without access to the Internet, traditional paper bid packages may be produced.

If the contractor or subcontractor has Internet access, they may link to the central server, enter a name and password (or register), and review the bid package. They may select any or all items to bid. The bid manager then presents a screen containing the items they selected and is used to submit their bids. The bid manager requires a dollar amount for each task and displays the total bid at the bottom of the screen. On this screen the contractor or subcontractor may indicate how they will forward submittals. Documents may be attached electronically or forwarded by carrier or postal mail.

When a contractor responds electronically to a bid package, the bid manager records the company/contact id, date and time submitted, and bid amount for each item bid on. If bids are submitted by carrier or postal mail, the general contractor or project manager may enter the information into the system in a fashion as if they were the bidder with Internet access.

At any time, the bid manager allows review of all bids received by task or by company. Bids may be accepted in whole or in part. If a bid is accepted in whole, the bid manager places the bid amounts on all appropriate tasks. If only certain bid items are accepted for a given company, their bid may be called to the screen and the appropriate items marked as accepted using check boxes or the like. Bid amounts are then placed on the respective tasks. In either case, when a bid is accepted, the bidder is notified by e-mail or fax that their bid has been accepted with a link to the “copy” of the accepted bid that resides on the central server. This “copy” remains linked with the task throughout the duration of the project.

Pro-Active Manager

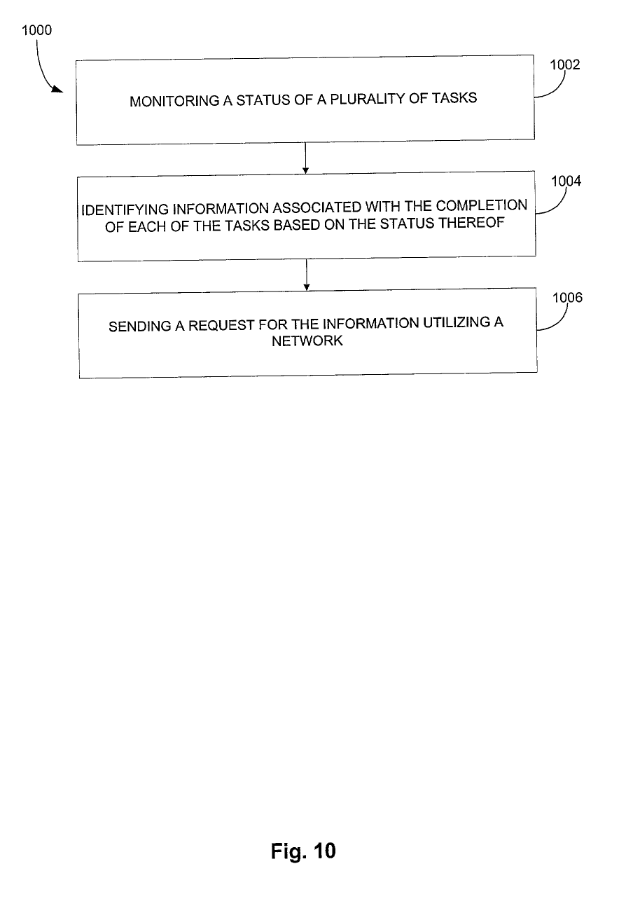

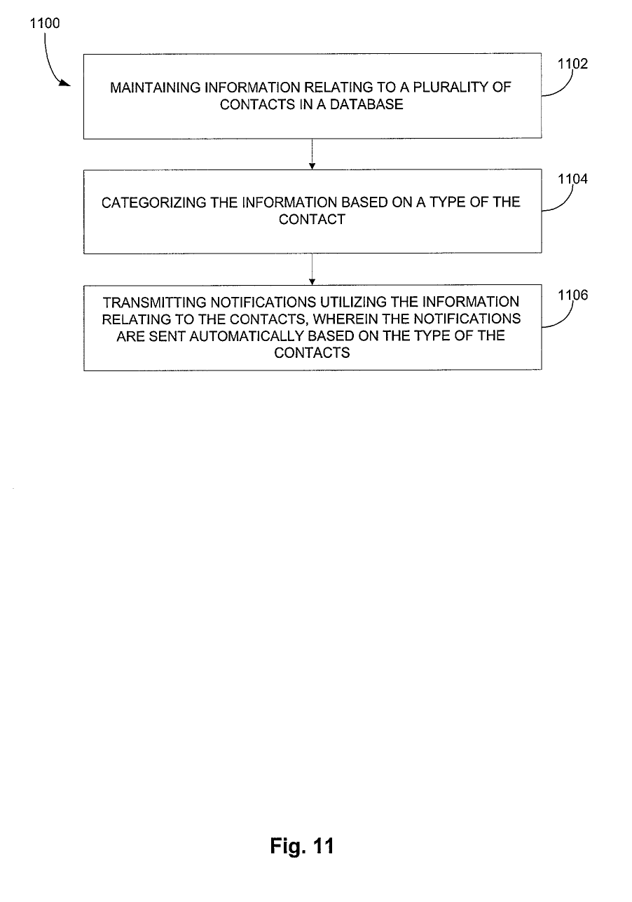

FIG. 10 illustrates a method 1000 for affording a pro-active manager. Initially, in operation 1002, a status of a plurality of tasks is determined. Such status may be determined in any desired manner. For example, the status may depend on whether a particular document has been completed, submitted, etc.

Further, in operation 1004, information associated with the completion of each of the tasks is identified based on the status thereof. Such information may be required for the completion of each of the tasks. Further, the information may include site pictures, a task completion percentage, manpower reports, and/or field directive reports.

Thereafter, in operation 1006, a request, i.e. e-mail notification, for the information is transmitted utilizing a network. Optionally, each task may have an identifier associated therewith, and the request may be sent to a particular user based on the identifier. Still yet, each type of information may have an identifier associated therewith, wherein the request is sent to a particular user based on the identifier.

In one embodiment of the present invention, the various steps of the present invention may be executed on a periodic, i.e. nightly, basis. The pro-active manager (PAM) may thus execute a nightly process that interacts with the other modules to collect information and send status alert emails, voicemails or faxes to the appropriate personnel. The pro-active manager has two primary functions:

1) Generate information collection requests from the appropriate contacts for a variety of information needed to keep the project on track. Examples of such information include:

Site pictures

Task completion %

Manpower reports

Field directive reports

Any other information that is task related and information is needed on a periodic basis

2) Alert the appropriate contacts about all items needing attention at the beginning of each day. Examples of such items include:

Site evaluations & assessments not returned by due date

Drawings or specifications not submitted by due date

Drawings or specifications retrieved from the document manager

Drawings or specifications retrieved and not re-submitted by due date

Bids returned and not returned by the due date

Any communication documents not returned by the due date

Critical path tasks each day

Task completion % that is behind schedule and on the critical path

Task % requested but not received

Site pictures requested but not received

Cost revisions

Company & Contact Manager

The companies and contact manager (CCM) contains all personnel and company information for all projects for a given General Contractor/Project Manager. The companies and contact manager functionality includes capturing all pertinent information relating to companies and contacts. See Tables 1 and/or 2.

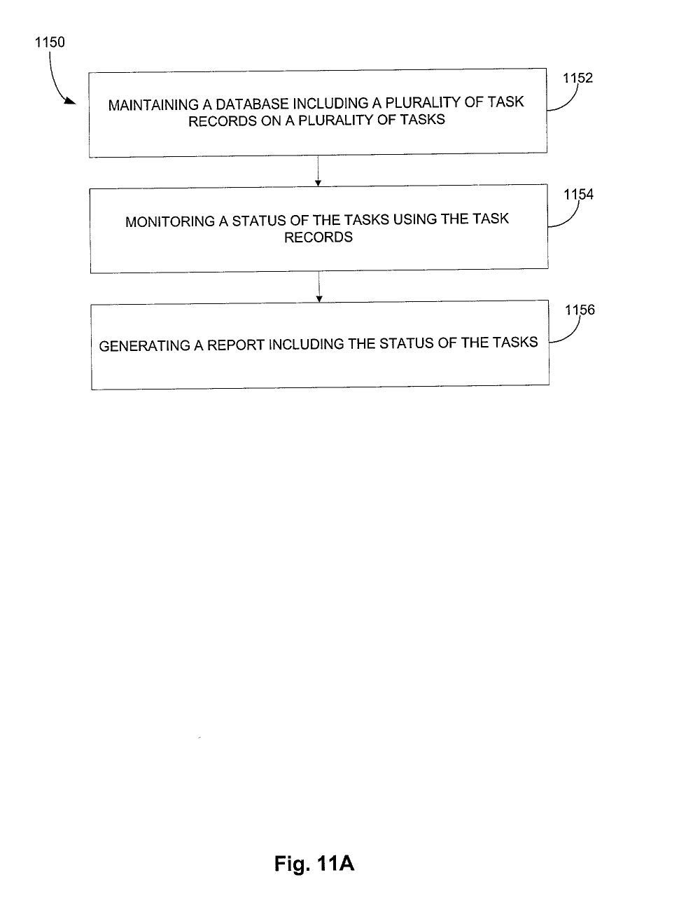

FIG. 11 illustrates a method 1100 for affording a contact manager. In operation 1102, information relating to a plurality of contacts is maintained in a database. Further, such information is categorized based on a type (i.e. company type, etc.) of the contact. See operation 1104.

Thereafter, in operation 1106, notifications are transmitted utilizing the information relating to the contacts. Such notifications are sent automatically based on the type of the contacts. Optionally, the notifications may include electronic mail messages. Moreover, the information relating to the contacts may be generated at least in part by an electronic mail browser. The notifications may also include requests to be fulfilled in order to complete a task.

In one embodiment, the contacts contain read/write company and contact manager flags, contacts contain read/write flags for the document manager & communication manger, and submit/retrieve flags for drawings & specifications. Further, companies and contact manager interacts in real-time or synchronizes information with the contact database of MICROSOFT OUTLOOK. Still yet, user defined company types, contact types, and grouping of contacts are provided.

The companies and contact manager also provides a search function by company, division, or contact. Such search function may be readily available to the user on any screen that asks the user to enter company or contact information (such as assigning task responsibility). Further, an alpha search may include category groupings within individual listings, similar to MICROSOFT OUTLOOK.

During a search, the present invention may allow additions of companies and contacts if they do not exist (and user is authorized). Moreover, the companies and contact manager provides an audit trail of any changes made to the company and contact information including date, time, and who made the change. The companies and contact manager may be designed to easily adapt to any industry requiring pro-active project management.

Reports Manager

FIG. 11A illustrates a method 1150 for affording a reports manager. Initially, in operation 1152, a database including a plurality of task records on a plurality of tasks is maintained. As an option, each task record may indicate each previous task carried out prior to the associated task, and further each subsequent task to be carried out after the associated task. Of course, each task record may include any information related to the associated tasks.

Further, in operation 1154, a status of the tasks is monitored using the task records. Optionally, the status of a task may be based on whether a document associated with the task has been completed, submitted, etc.

A report including the status of the tasks may thereby be generated. Note operation 1156. As an option, the report may be included in an electronic mail message. Further, a destination of the electronic mail message may be defined for each task.

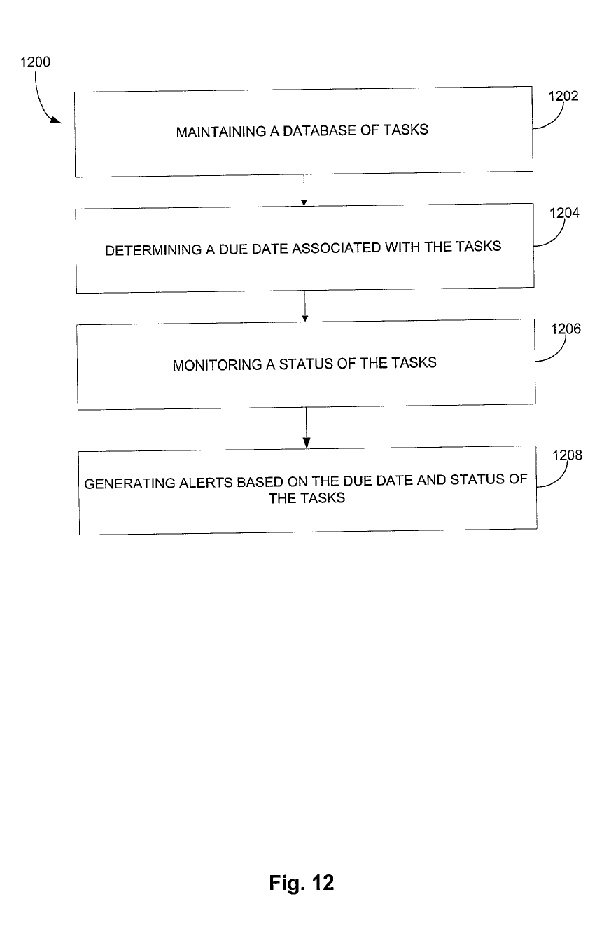

FIG. 12 illustrates a method 1200 for alerting a manager of an outstanding task. Such a feature may be afforded by any combination of the foregoing elements.

Initially, in operation 1202, a database of tasks is maintained. Further, in operation 1204, a due date associated with the tasks is determined. During use, a status of the tasks is monitored. See operation 1206. As an option, the status may provide an indication as to whether documents associated with the tasks have been submitted to the database.

As such, alerts may be generated based on the due date and status of the tasks. Note operation 1208. Further, the alerts may include electronic message notifications transmitted utilizing a network, i.e. the Internet. Optionally, the alerts may be transmitted to a manager.

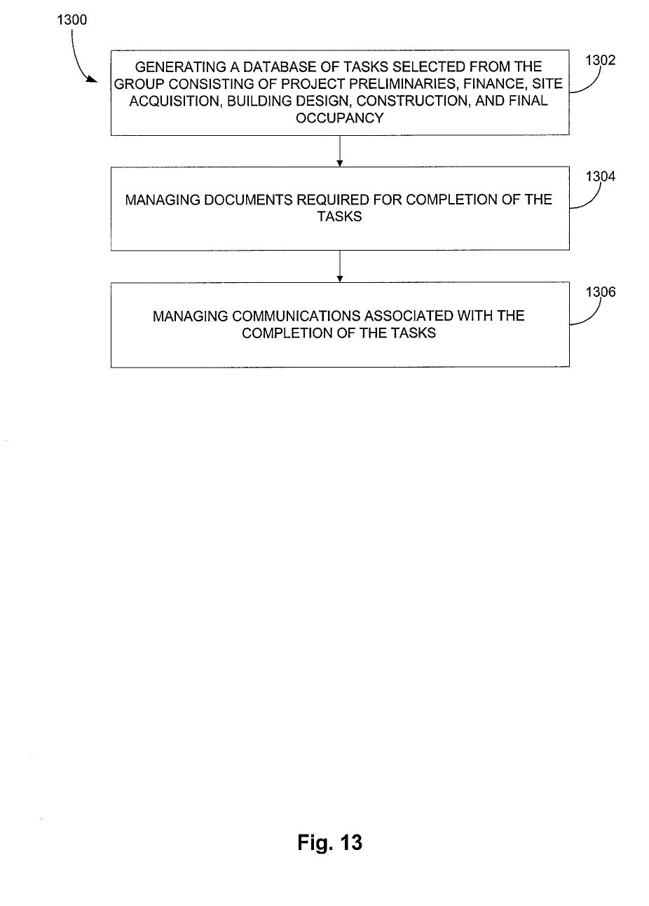

As set forth hereinabove, one application of the various principles of the present invention includes the construction industry. In accordance with such environment, FIG. 13 illustrates a method 1300 for managing a construction process. Initially, in operation 1302, a database of tasks is generated, where the tasks include project preliminaries, finance, site acquisition, building design, construction, and/or final occupancy. During use, documents required for completion of the tasks are managed. See operation 1304. Further, in operation 1306, communications associated with the completion of the tasks is managed.

The present design is thus superior to prior art systems for the following reasons:

The present invention integrates scheduling with many other standard A/E/C system functions such as estimating, bidding, document management, budgeting and accounting.

The present invention is pro-active, sending email or fax messages to appropriate personnel when unfinished tasks or documents may affect the ability to keep the project on time and on budget.

The present invention will not require architects, engineers and sub-contractors to learn additional Web ASP applications (although they may if they desire) as the present invention will use proprietary email, voicemail, HHD & fax managers at the host site. For architects, engineers and sub-contractors, information and documents may be passed along through any of these channels.

The present invention provides larger firms with the alternative of hosting themselves.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a graphical sender interface for task management, comprising the steps of:
(a) displaying a plurality of fields including a recipient field, a message field, and a response date field;
(b) allowing a sender to enter of a recipient of an electronic mail message utilizing the recipient field;
(c) permitting the sender to enter text to accompany the electronic mail message utilizing the message field; and
(d) letting the sender specify a response date using the response date field.

2. The method as recited in claim 1, and further comprising the step of sending electronic mail alerts automatically based on the response date.

3. The method as recited in claim 3, wherein the electronic mail alerts are sent to the recipient.

4. The method as recited in claim 4, wherein the electronic mail alerts are sent to the sender.

5. The method as recited in claim 1, wherein at least two message fields are displayed including a request message field and a response message field.

6. The method as recited in claim 1, wherein a project field is displayed for allowing the sender to enter project information, and a subject field is displayed for allowing the sender to enter subject information.

7. A computer program product for providing a graphical sender interface for task management, comprising:
(a) computer code for displaying a plurality of fields including a recipient field, a message field, and a response date field;
(b) computer code for allowing a sender to enter of a recipient of an electronic mail message utilizing the recipient field;
(c) computer code for permitting the sender to enter text to accompany the electronic mail message utilizing the message field; and
(d) computer code for letting the sender specify a response date using the response date field.

8. The computer program product as recited in claim 7, and further comprising computer code for sending electronic mail alerts automatically based on the response date.

9. The computer program product as recited in claim 8, wherein the electronic mail alerts are sent to the recipient.

10. The computer program product as recited in claim 9, wherein the electronic mail alerts are sent to the sender.

11. The computer program product as recited in claim 7, wherein at least two message fields are displayed including a request message field and a response message field.

12. The computer program product as recited in claim 7, wherein a project field is displayed for allowing the sender to enter project information, and a subject field is displayed for allowing the sender to enter subject information.

13. A system for providing a graphical sender interface for task management, comprising:
(a) logic for displaying a plurality of fields including a recipient field, a message field, and a response date field;
(b) logic for allowing a sender to enter of a recipient of an electronic mail message utilizing the recipient field;
(c) logic for permitting the sender to enter text to accompany the electronic mail message utilizing the message field; and
(d) logic for letting the sender specify a response date using the response date field.

14. The system as recited in claim 13, and further comprising logic for sending electronic mail alerts automatically based on the response date.

15. The system as recited in claim 14, wherein the electronic mail alerts are sent to the recipient.

16. The system as recited in claim 15, wherein the electronic mail alerts are sent to the sender.

17. The system as recited in claim 13, wherein at least two message fields are displayed including a request message field and a response message field.

18. The system as recited in claim 13, wherein a project field is displayed for allowing the sender to enter project information, and a subject field is displayed for allowing the sender to enter subject information.
